(19) United States
(12) Patent Application Publication
(10) Pub. No.: US 2026/0183671 A1
(43) Pub. Date: Jul. 2, 2026

(54) User Profile Generator Using Machine Learning Deployed with a Game Engine Runtime

(71) Applicant: Unity Technologies SF, San Francisco, CA (US)

(72) Inventors: Sampsa Valtteri JAATINEN, Long Beach, CA (US); Alexandre RIBARD, Montréal (CA)

(21) Appl. No.: 19/438,429

(22) Filed: Dec. 31, 2025

Related U.S. Application Data
(60) Provisional application No. 63/740,712, filed on Dec. 31, 2024.

(51) Int. Cl. A63F 13/67; A63F 13/35

(52) U.S. Cl. CPC A63F 13/67; A63F 13/35

(57) ABSTRACT

A client device communicates with a game server and comprises a processor, an embeddings manager, configured to perform a federated learning process using models to create embeddings, wherein an embedding represents a compression of data generated from signals on the client device representing user interactions, and an embedding model storage for storing embedded models accessible at the client device.

### CROSS-REFERENCES TO PRIORITY AND RELATED APPLICATIONS

This application is a non-provisional of, and claims the benefit of and priority from, U.S. Provisional Patent Application No. 63/740,712 filed Dec. 31, 2024, entitled “User Profile Generator Using Machine Learning Deployed with a Game Engine Runtime.”

### FIELD

The present disclosure generally relates to game engines used on computing devices and more particularly to deploying a game engine runtime that generates distilled user profiles.

### BACKGROUND

Having user profiles for users of a game or other software is useful for providing recommendations, rankings, and advertisement selection. In some systems, user profiles are derived from demographic data, such as user-provided data indicating their gender, age, income level, interests, etc. This information might be useful but not be indicative of a user's interests. In some systems, detailed actions of a user (e.g., what apps they run, what they type in, what content they viewed) and behaviors of the user (e.g., where they travelled to, who they communicated with) might be collected by a mobile device app, fed to a server that then determines or estimates user interests. There are privacy concerns about having a mobile device disseminate such detailed information and the bandwidth needed might be a significant network burden, even if such detailed data could be used for predicting user interests generally.

It would be useful to have some methods and apparatus for maintaining user privacy while still being able to infer user interests.

### BRIEF DESCRIPTION OF THE DRAWINGS

Various embodiments in accordance with the present disclosure will be described with reference to the drawings, in which:

FIG. 1 is a block diagram of a gaming environment in which client devices can obtain games, play games, and provide games, recommendations, and advertisements, such as in-game advertisements, that are of interest to the users of the client devices.

FIG. 2 is a block diagram showing the client device of FIG. 1 in greater detail including interactions between other elements of the gaming environment shown in FIG. 1

FIG. 3 illustrates data flows for an in-game ad selection and presentation, according to various embodiments.

FIG. 4 illustrates data flows for an embedding processing, according to various embodiments.

FIG. 5 illustrates an example computer system memory structure as might be used in performing methods described herein, according to various embodiments.

FIG. 6 is a block diagram illustrating an example computer system upon which the systems illustrated in FIGS. 1 and 5 may be implemented, according to various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Using the methods and apparatus described herein, a gaming environment might provide for acquiring information about the mobile game players as they are playing a game but do so in a privacy-preserving and a bandwidth-conserving way. Assessments about a user's interest might be made from data signals available on a device. For example, if a user interacts with a game for hours at a time and when interacting with a target might tap their screen display at a rapid frequency, they might be a high-intensity gamer and would be more receptive to recommendations of more intense new games. On the other hand, if the user only interacts during short periods of time, they might be more interested in simpler games. In making such assessments of a user's interests, the detailed data about the user's interactions with their device and game apps or other apps on the device isn't needed as much as a distilled representation such as “this person is interested in intense first-person shooting games”, “this person is interested in world-building games”, etc. In some applications, the exact nature of the user's interest might not be needed, and it might be sufficient to be able to determine that user A has a lot in common with the group of users G without knowing, or needing to know, what it is that they have in common.

Analyzing data signals on the device outside of the device might raise privacy concerns and might be too voluminous. As explained herein, raw device data can be provided to an embeddings manager on the device (possibly running as part of a game engine runtime and/or as a background process). The embeddings manager can use machine learning models to process and to compress the raw device data in a way that it cannot be deconstructed to tell something particular about the user, but would still be beneficial for user interest determining, such as for advertisement targeting. A models server can serve an initial model to the embeddings manager, which can then further train the model to be able to output distilled embeddings as irreversible aggregates. The embeddings manager might, in some embodiments, coordinate with a model generator server to perform federated learning wherein individual devices can contribute to training what could be subsequent initial models.

An embedding can be represented in memory as compressed data or reduced dimensions and can be provided to an ad manager in response to an embedding request. Such interactions might be built into the game engine runtime and accessed according to a software development kit (SDK). The embedding can be encrypted. In some embodiments, the embedding need not be encrypted but the encryption can help ensure that if another party manages to call the API or intercept the traffic, the content of it will be meaningless. An embedding can be an irreversible aggregate in that data is aggregated in a loss-full process.

Mobile devices constantly produce and provide information feeds through API's that are rich but should be considered sensitive. As an example. A mobile device might provide a game engine with device accelerometer data, data about screen touches (position, pressure, time), etc. via API calls by the game engine to a device O/S API interface. The accelerometer data can indicate device orientation and orientation changes. Screen touch data can indicate where on the screen the user touched, how much pressure was used, the duration of the touch, etc. This device O/S data might be combined with game engine runtime calls so that game activity can be combined with user interface activity. For example, knowing that the user touched a point on the screen at coordinates (0.4, 0.77) might be less useful than knowing that the user touched that point when the game was displaying a rectangle with diagonal vertices of (0.3, 0.5) and (0.5, 0.8) and that rectangle was a specific dialog box in the game. By combining device O/S data streams and game engine data streams, that connects motion and screen touch events to what is taking place in a game application.

Examples of signals that might make up an O/S data stream might include accelerometer signals that might indicate device position and/or movement, screen touches, button presses, etc. Other signals that might be used might include microphone audio, camera imagery, video captures, device location, data transfer (sent/received), memory usage, and other such signals. Data other than O/S activity and stream data might also be combined with game engine runtime call data, such as which API calls are made, physics simulation activity, render time, objects on screen, etc.

Instead of streaming all of this data out of the device, it can be distilled in a more resource-and privacy-sensitive way, such as processing it on the device into an irreversible aggregate.

An irreversible aggregate can provide for lossy compression of the data. The compressed data cannot be reverse engineered to produce the original data as the detailed information is lost in the compression process. The irreversible could be represented by an embedding that is a dense vector, which can be a latent descriptor of an essence of a distribution but has no meaning in isolation. The meaning captured in an embedding might be the relative similarity or difference of these embeddings across a user population rather than an absolute statement. Relative similarity might provide information such as “We can determine that two users are behaving the same way, but we cannot know what either of them are doing”.

These small aggregates could be sent from the device as part of a valuation request. The data passed with the request can be further used as input for a core advertising model.

Core advertising models might include a conversion model, a user value model, a minimum bid to win model, etc. A conversion model might be used to predict a likelihood of a game player installing a new game as an outcome of them seeing a mobile video ad for the game. A user value model might be used to predict a value of the user in the new game that they potentially installed after seeing an ad. The value might be determined as the revenue generated in the new game through transactions or other monetization mechanisms such as advertisement publishing. A “minimum bid to win” model might be related to real time auction mechanisms where, in addition to a value of ads impressions, the model is used to predict what will be the first price from other participants in a first price auction where an ad impression is being sold. In some embodiments, separate models might be trained, used, and updated. In some embodiments, one model might cover more than one of conversion, user value, and minimum bid to win.

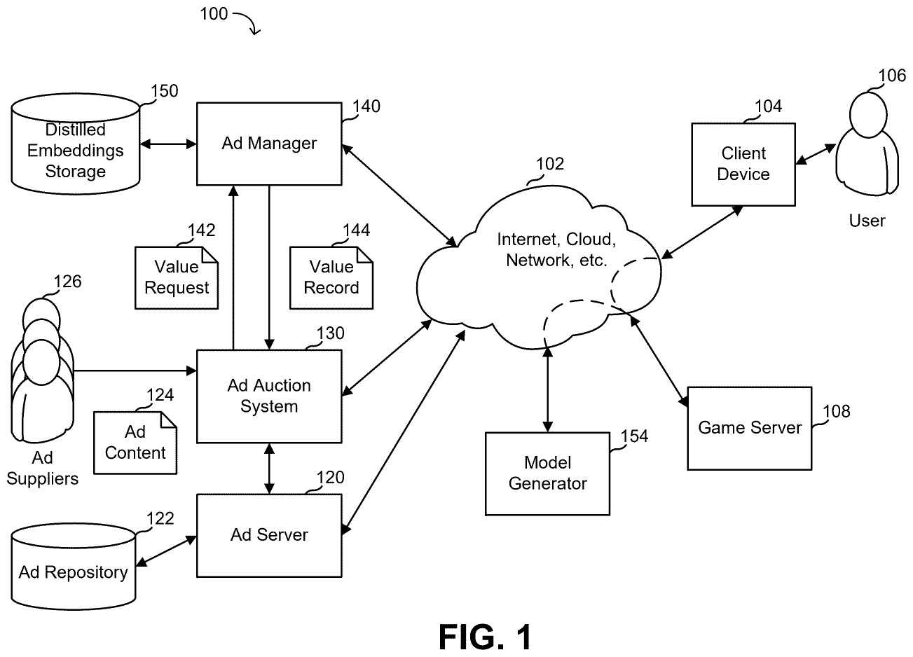

FIG. 1 is a block diagram of a gaming environment 100 in which client devices can obtain games, play games, and provide games, recommendations, and advertisements, such as in-game advertisements, that are of interest to the users of the client devices. Gaming environment 100 might include a number of components interconnected via a network 102, distributed over cloud services, and/or the Internet, to provide games and possibly other content to a client device 104, which a user 106 might interact with. In this illustration, only one client device and one user are shown, but it should be understood that gaming environment 100 might simultaneously serve thousands or millions of client devices and users. User 106 might interact with client device 104 during the playing of a game and a gaming app might be supplied by a game server 108. In connection with operating the gaming app, the gaming app may directly or indirectly request an advertisement object from an ad server 120, where the advertisement object is a data structure usable for generating and presenting an in-game advertisement on client device 104.

Ad server 120 might pull ads from an ad repository 122, which might contain ads such as ad content 124 supplied by an ad supplier 126. Where there are more ads available than there are opportunities to present in-game ads, an ad auction system 130 might be used to auction a limited number of advertising opportunities to ads suppliers 126. Ad auction system 130 might be informed about a particular value or characteristic of a user of a set of users with information provided by an ad manager 140. In some implementations, ad auction system 130 makes a value request 142 to ad manager 140 and receives back a value record 144 indicating a predicted value for an advertisement to user 106. The predicted value for an advertisement to particular user might be a function of the relevance of a particular advertisement to that user and the relevance might be determined from an embedding obtained by ad manager 140 from client device 104 stored in distilled embeddings storage 150. A model generator 154 might provide an initial model to scratch that might receive an initial model from a model generator 154.

In some embodiments, ad server 120 is a conventional ad server and ad manager 140 handles processing of embeddings that represent user activities. In some embodiments, an ad server and ad manager might be a unified operation.

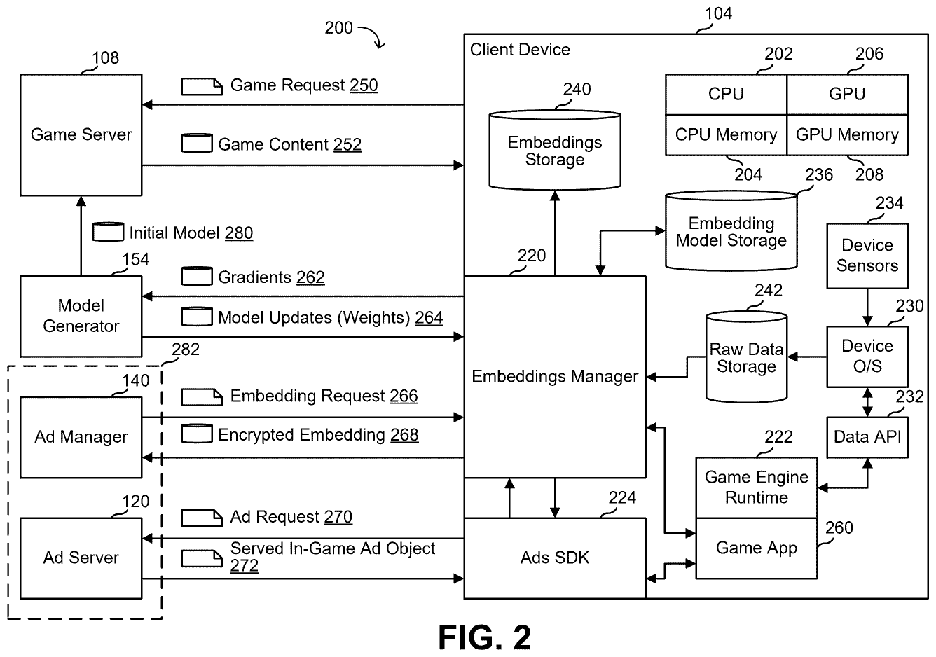

FIG. 2 is a block diagram of an environment 200 showing client device 104 of FIG. 1 in greater detail including interactions between other elements of a gaming environment, such as is shown in FIG. 1. As illustrated there, client 104 might include a CPU 202, a CPU memory 204, a GPU 206, a GPU memory 208, an embeddings manager 220, a game engine runtime 222, and an ads SDK 224. CPU 202 and CPU memory 204 might be configured to execute program instructions to implement features and elements present in client device 104 including the elements shown in FIG. 2. GPU 206 and GPU memory 204 might be configured to execute program instructions to implement graphics chip intensive operations and might be used for updating, creating, etc. embeddings. In some cases, a CPU alone might be present. In some embodiments, a CPU might be used to execute a game app and a game engine runtime, while a GPU might be used to do graphics rendering for the game app or for game engine runtime and the GPU might be used to update the models used by embeddings manager 220.

Game engine 252 might interact with a device operating system (O/S) 230 via a device data API 232, which might collect device sensor signals from device sensors 234. Device O/S 230 might be configured to output data representing those device sensor signals to a raw data storage 242. Raw data storage 242 might contain too much data to be able to efficiently export from client device 104 and might reveal too much about a user's interaction with client device 104. Embeddings manager 220 might also provide embeddings to an embeddings storage 240 and store embedding models into an embedding model storage 236.

Client device 104 might make a game request 250 of game server 108, which might return a game content 252 as an object that client device 104 can then execute as a game app 260. When executing, game app 260 interfaces with game engine runtime 222 and with embeddings manager 220.

Embeddings manager 220 can provide model generator 154 with a set of gradients 262 and receive model updates 264, which might be in the form of a set of updated weights. Model generator 154 might provide an initial model 280 to game server 108. Ad manager 140 might send an embedding request 266 to embedding manager 220 and receive back data representing an encrypted embedding 268. Ad server 120 might receive an ad request 270 from ads SDK 224 and return a served in-game ad object 272. In some embodiments, ad manager 140 and ad server 120 are an integrated ad manager/server 282.

Model generator 154 can perform an offline initial training/creation of embeddings models. These can be trained as deep autoencoders, a transformer architecture such as BERT, GPT, or similar, etc.

The user profile, given that it is compactly representing data about user engagement, can be used to derive an engagement metric and the methods and apparatus described herein could be used in implementing an engagement API that an application might call to receive a representation of the engagement metric, which might be updated in real time. For example, embedding manager 220 might expose an API that game engine runtime 222 can call or that game app 260 can call to obtain the engagement metric or an embedding that could be used to determine the engagement metric. The embedding might be constructed with federated learning. The engagement metric can be provided to game developers to observe, analyze, and utilize with the player treatment and game improvements, such as through integrated ad manager/server 282. The engagement metric can be used by game app 260 and might be provided back to game server 108 for use by game developers.

Embeddings manager 220 might further train an embeddings model to take raw data from mobile device operation, as might be stored in raw data storage 242 and create encrypted embedding 268 for a second separate ML model that might run on ad manager 140 and could decrypt and use the embedding for making machine learning predictions. For example, the second ML model might perform ad selection and delivery based in part on the received embedding or perform other processes.

An example of raw data that is input for embedding manager 220 might include 15 or 30 seconds of data signal captured at a frequency of 10 Hz, 20 Hz, 60 Hz, etc. from an accelerometer accessed via device O/S 230 and/or device data API 232. An output of embedding manager 220 using an embedding model might be a dense vector (e.g., a vector of 50, 100, 150, etc. floating-point numbers) that is stored in embeddings storage 240 as an embedding object.

Once initial training is complete, the trained embedding model can be deployed to a mobile device. The embeddings model can run on the device to generate embeddings over time, or by request (e.g., from an ads SDK).

The model might be implemented as a part of game engine runtime 222, that would allow the execution to live in the O/S native layer. Game engine runtime 222 might include the embeddings ML model and run it on a device background process on the device native operating system layer. This can be non-invasive for the device's performance and have limited impact on memory, battery, or other device faculties. Embeddings manager 220 might expose an encrypted API that would return an embedding output of the embeddings model. Embedding manager 220 might create embeddings periodically (e.g., every 30 seconds, with a data sample frequency of 1/second).

The embedding might be treated as the user profile as is, or the embedding might be provided with a separate profile record at request time. The embedding might be sent from the device with the request. The embeddings might be stored with some low frequency and form a yet another “time series” aggregate over these profiles. This might involve persisting the embeddings, which might be persisted anyway, for example to be able to use them as inputs for another model.

Client device 104 might receive a request for an embedding from ad manager 140 and invoke embeddings manager 220 to generate a fresh embedding. For example, ads SDK 224 running on client device 104 might request an embedding via an exposed API in order to relay the embedding to ad manager 140, which might then provide user profile info to an ad auction system. When ads SDK 224 is ready to make an ad-request from the server, it might call the API and send the embedding out (encrypted) with the request. A server-side system, such as ad manager 140, can then receive the data, decrypt it, and use it as part of the request context when making machine learning predictions.

Asynchronous updating/retraining of the embeddings model might be done. The initial training of the model happens on the server side, but once live, the model can be retrained per a schedule employing federated learning principle. This allows training the model without sending the raw data from the device to the server. The only information that might need to be passed back and forth is model-related, not individual related parameters (outbound model gradients, inbound model weights). Inbound model weights might be data that is provided to embeddings manager 220 as new model weights. Embeddings manager 220 can then emit embeddings and model gradients.

### Potential Use Cases and Examples

1. Onboarding helper—for a new game, the embeddings could be used to a “confusion level” of a new player and understand when they need guidance. This information can be used to trigger pop-up notifications to timely and meaningfully guide the player.
2. Frustration—the device can observe changes in the players'agitation or excitement, which can be valuable feedback to a game developer for optimizing a game difficulty, game balance, or overall gaming mechanics.
3. Engagement score—The embeddings manager can provide an API that outputs as combined metrics from different signals how engaged the player is. Highly engaged players can have a higher propensity to react to promotions and purchase.
4. Fraud detection—If there are no physical screen touches, nor motion of the device, the embedding might reflect that if a game is being played, it is probably in a simulation.
5. Context monitoring—In which context the players typically are when they play the game. Motion can reveal if they are in transit (car/bus/train), potentially waiting for a transport or if they are fully relaxed (sitting down, laying down).
6. Sleep Mode—The game could sense when the player has fallen into a sleep and could automatically pause/turn down the volume.

The embeddings models can be implemented and distributed on the device as part of the runtime or game application download. The models can be implemented to run in background process threads. Data from the APIs can be collected by the runtime and stored in a wrap-around buffer that always has the latest N data recordings, where N can be a suitable number. The models can be applied periodically with a low frequency to the data that is buffered and an embedding is outputted in a way that overwrites the previous iteration.

The embeddings buffer can be accessed through an API that can be called by the ads SDK. The API might return the most recent embedding in a format that is encrypted. The ads SDK might pass the embedding to the ad server with the ad request where it can be further utilized.

Model updates might be implemented with two additional API's, a gradients API that returns model gradients, and a weights API that allows setting new weights to the model. Together these additional APIs can enable a federated learning capability, where the model training is federated through passing the gradients from the device to the server, and passing the updated model weights from the server to the device.

The embedding models can be created from a buffer of timeseries data. The time series data might be processed with one-dimensional (1D) convolution, transformers, or other methods.

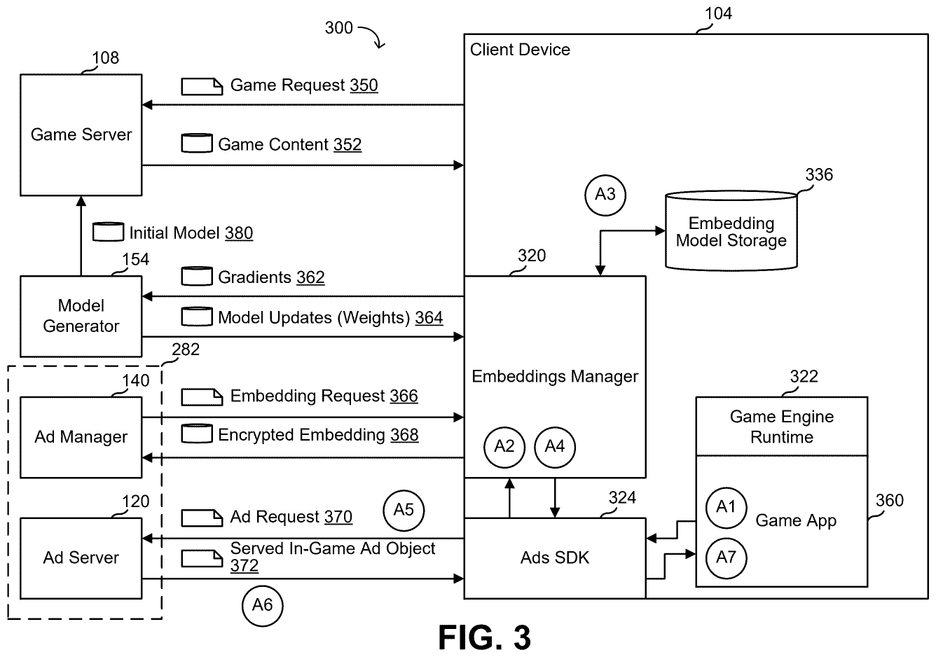

FIG. 3 illustrates data flows for an in-game ad selection and presentation process, according to various embodiments. As shown there, in an environment 300, the process begins at step A1 with game app 360 requesting an in-game ad from ads SDK 324, which might actually be a bid. Ads SDK 324 at step A2 then calls embeddings manager 320, possibly through an embeddings API. Embeddings manager 320 then consults with embedding model storage 336 at step A3 and returns an embedding to ads SDK 324 at step A4. Ads SDK 324 then makes an ad request to ad server 120 at step A5, passing the embeddings, among other things, to ad server 120. Ad server 120 might do some server-side machine learning (ML) for ad selection, possibly consulting ad manager 140, using the provided embeddings. Ad server 120 then returns a selected in-game ad in an in-game ad object at step A6. Ads SDK 324 then supplies game app 360 with the selected ad at step A7. Game app 360 might include a game engine runtime 322.

In a specific flow, client device 104 might first make a game request 350 to game server 108 and receive game content 352, which client device 104 might execute as game app 360. During operations, or at other times, embeddings manager 320 might submit gradients 362 to model generator 154, which might generate an initial model 380 and also provide model updates 364, as weights or otherwise, back to embeddings manager 320. From time to time, ad manager 140 might issue to embedding manager 320 an embedding request 366 and receive back an encrypted embedding 368. Client device 104 might make a game request 350 of game server 108, which might return a game content 352 as an object that client device 104 can then execute as a game app 360. When executing, game app 360 interfaces with game engine runtime 322 and with embeddings manager 320, via ad SDK 324.

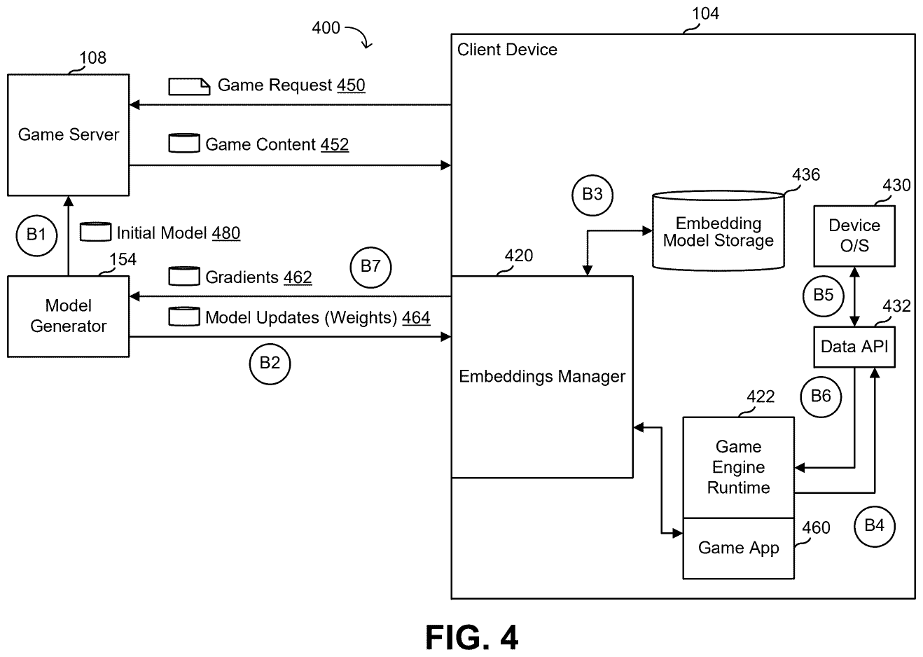

FIG. 4 illustrates data flows for an embedding processing, according to various embodiments. As shown there, in an environment 400, the process begins with step B1 with model generator 154 providing initial model 480 to game server 108. Model generator 154 also provides model updates to embeddings manager 420 at step B2. At step B3, embeddings manager 420 updates weights in embedding model storage 436. Then, at step B4 game engine 422 gathers device information via data API 432, which obtains the data from device O/S 430 step B5 and at step B6, data API 432 returns the data to game engine. Then, at step B7, embeddings manager 420 provides gradients 462 to model generator 154. Ads SDK 324 might issue an ad request 370 to ad server 120 and receive back a served in-game ad object 372.

During operations, or at other times, embeddings manager 420 might submit gradients 462 to model generator 154, which might generate an initial model 480 and also provide model updates 464, as weights or otherwise, back to embeddings manager 420. Client device 104 might make a game request 450 of game server 108, which might return a game content 452 as an object that client device 104 can then execute as a game app 460.

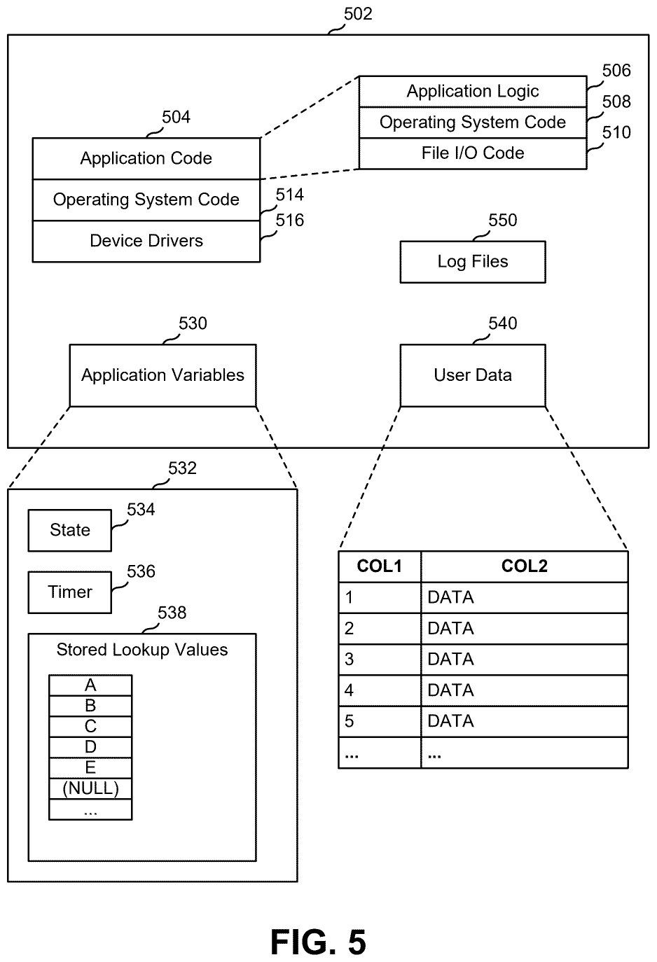

FIG. 5 is a simplified functional block diagram of a storage device 502 having an application that can be accessed and executed by a processor in a computer system as might be part of embodiments of a gaming environment or elements thereof, and/or a computer system that performs one or more methods described herein. FIG. 5 also illustrates an example of memory elements that might be used by a processor to implement elements of the embodiments described herein. In some embodiments, the data structures are used by various components and tools, some of which are described in more detail herein. The data structures and program code used to operate on the data structures may be provided and/or carried by a transitory computer readable medium, e.g., a transmission medium such as in the form of a signal transmitted over a network. For example, where a functional block is referenced, it might be implemented as program code stored in memory. The application can be one or more of the applications described herein, running on servers, clients or other platforms or devices and might represent memory of one of the clients and/or servers illustrated elsewhere.

Storage device 502 can be one or more memory device that can be accessed by a processor and storage device 502 can have stored thereon application code 504 that can be one or more processor readable instructions, in the form of write-only memory and/or writable memory. Application code 504 can include application logic 506, library functions 508, and file I/O functions code 510 associated with the application. The memory elements of FIG. 5 might be used for a server or computer that interfaces with a user, generates data, and/or manages other aspects of a process described herein. In addition to application code 504, storage device 502 might also contain operating system code 514 and device drivers 516.

Storage device 502 can also include storage for application variables 530 that can include one or more storage locations configured to receive variables 532. Application variables 530 can include variables that are generated by the application or otherwise local to the application, such as state variables 534, timers 536, and/or stored lookup values 538. Application variables 530 can be generated, for example, from data retrieved from an external source, such as a user or an external device or application. A processor can execute application code 504 to generate application variables 530 provided to storage device 502. Application variables 530 might include operational details needed to perform the functions described herein.

Storage device 502 can include storage for databases and other data described herein. One or more memory locations can be configured to store user data 540, which might include data sourced by an external source, such as a user or an external device. User data 540 can include, for example, records being passed between servers prior to being transmitted or after being received. Other data might also be supplied.

Storage device 502 can also include log files 550 having one or more storage locations configured to store results of the application or inputs provided to the application. For example, log files 550 can be configured to store a history of actions, alerts, error messages, and the like.

According to some embodiments, the techniques described herein are implemented by one or more generalized computing systems programmed to perform the techniques pursuant to program instructions in firmware, memory, other storage, or a combination. Special-purpose computing devices may be used, such as desktop computer systems, portable computer systems, handheld devices, networking devices, or any other device that incorporates hard-wired and/or program logic to implement the techniques.

One embodiment might include a carrier medium carrying data that includes data having been processed by the methods described herein. The carrier medium can comprise any medium suitable for carrying the data, including a storage medium, e.g., solid-state memory, an optical disk or a magnetic disk, or a transient medium, e.g., a signal carrying the data such as a signal transmitted over a network, a digital signal, a radio frequency signal, an acoustic signal, an optical signal or an electrical signal.

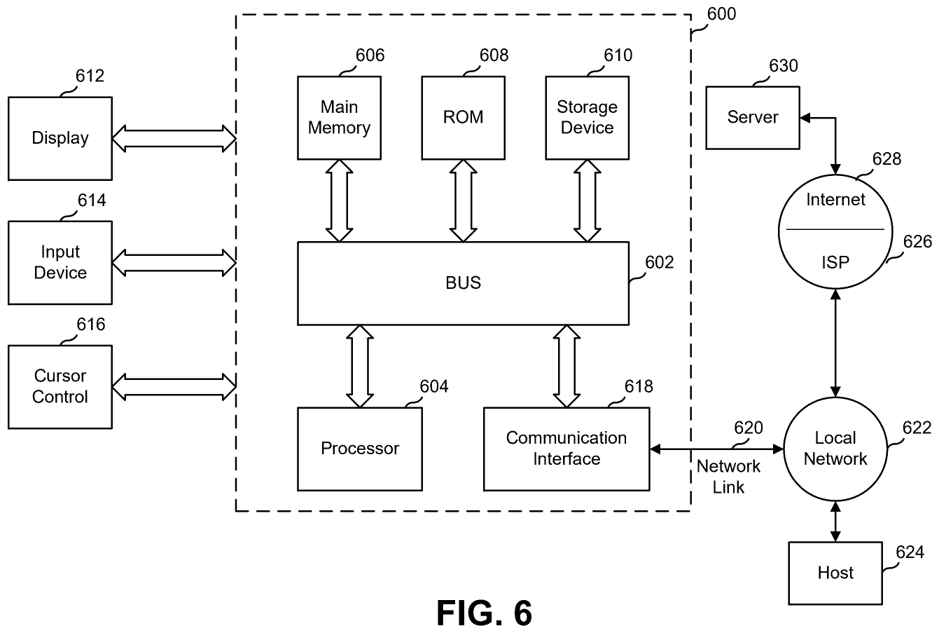

FIG. 6 is a block diagram that illustrates a computer system 600 upon which the computer systems of the systems described herein and/or data structures shown in FIG. 5 may be implemented. Computer system 600 includes a bus 602 or other communication mechanism for communicating information, and a processor 604 coupled with bus 602 for processing information. Processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 may also be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a computer monitor, for displaying information to a computer user. An input device 614, including alphanumeric and other keys, is coupled to bus 602 for communicating information and command selections to processor 604. Another type of user input device is a cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware, and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may include non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that include bus 602. Transmission media can also take the form of acoustic or light waves, such as those generated during radio-wave and infrared data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a network connection. A modem or network interface local to computer system 600 can receive the data. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be a network card, a modem, a cable modem, or a satellite modem to provide a data communication connection to a corresponding type of telephone line or communications line. Wireless links may also be implemented. In any such implementation, communication interface 618 sends and receives electrical, electromagnetic, or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world-wide packet data communication network now commonly referred to as the “Internet” 628. Local network 622 and Internet 628 both use electrical, electromagnetic, or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620, and communication interface 618. In the Internet example, a server 630 might transmit a requested code for an application program through the Internet 628, ISP 626, local network 622, and communication interface 618. The received code may be executed by processor 604 as it is received, and/or stored in storage device 610, or other non-volatile storage for later execution.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The code may also be carried by a transitory computer readable medium e.g., a transmission medium such as in the form of a signal transmitted over a network.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A client device that communicates with a game server, comprising:
a processor;
an embeddings manager, configured to perform a federated learning process using models to create embeddings, wherein an embedding represents a compression of data generated from signals on the client device representing user interactions; and
an embedding model storage for storing embedded models accessible at the client device.

2. The client device of claim 1, further comprising an ads SDK configured to request an embedding from the embeddings manager via an API of the embeddings manager and configured to send an encrypted version of the embedding to a remote ad manager.

3. The client device of claim 1, wherein the signals on the client device represent accelerometer data, and/or data about screen touches in position, in pressure, and/or in time.

4. The client device of claim 1, wherein embedding is represented by a dense vector.

5. A method of processing embeddings representing user engagement activity with a client device, the method comprising:
initiating initial creation of an embeddings model remote from the client device; and
running the embeddings model on the client device.

6. The method of claim 5, wherein initiating the initial creation of the embeddings model comprises training the embeddings model using one or more of a deep autoencoder, a BERT transformer, or a GPT engine.

7. The method of claim 5, further comprising transmitting the embedding model to the client device.

8. The method of claim 5, wherein the embedding model is adapted to operate as part of a game runtime engine on the client device.

9. The method of claim 5, further comprising retraining the embeddings model asynchronously, wherein the initial creation of the embeddings model comprises training performed at a server, and wherein the retraining is performed per a schedule employing federated learning.

10. A non-transitory computer-readable storage medium storing instructions, which when executed by at least one processor of a computer system, causes the computer system to carry out the method of any one of claims 5 to 9.
